(19) United States
(12) Patent Application Publication
(10) Pub. No.: US 2017/0355544 A1
(43) Pub. Date: Dec. 14, 2017

(54) CONVEYANCE DETECTION APPARATUS, CONVEYING APPARATUS, AND RECORDING APPARATUS

(71) Applicant: CANON COMPONENTS, INC., Kodama-gun (JP)

(72) Inventors: Kenichi MATSUMOTO, Saitama (JP); Yoshihiro HATTORI, Saitama (JP); Yoshihisa NEGISHI, Saitama (JP); Masashi ISHIMARU, Saitama (JP); Hironobu MIZUNO, Saitama (JP)

(21) Appl. No.: 15/618,489

(22) Filed: Jun. 9, 2017

(30) Foreign Application Priority Data
Jun. 14, 2016 (JP) 2016-117866

(51) Int. Cl. B65H 7/14; G06K 9/00; G06K 9/46; B65H 5/06

(52) U.S. Cl. CPC B65H 7/14; B65H 5/062; G06K 9/0063; G06K 9/4671; B65H 2404/14; B65H 2511/20; B65H 2801/06; B65H 2801/12; B65H 2553/42

(57) ABSTRACT

Provided is a control unit of a conveying apparatus, the conveying apparatus including: a conveying unit that conveys recording paper along a conveying path; and an imaging unit that images the recording paper and an object not conveyed by the conveying unit, wherein the control unit acquires actual conveyance information of the recording paper from image information of the recording paper imaged by the imaging unit and image information of the object imaged by the imaging unit.

### CROSS-REFERENCE TO RELATED APPLICATIONS

This application is based upon and claims the benefit of priority of the prior Japanese Patent Application No. 2016-117866, filed on Jun. 14, 2016, the entire contents of which are incorporated herein by reference.

### BACKGROUND OF THE INVENTION

### Field of the Invention

The present invention relates to a conveyance detection apparatus, a conveying apparatus, and a recording apparatus.

### Description of the Related Art

There is a known recording apparatus that conveys a recording medium while controlling an amount of conveyance and that records an image on the recording medium. A recording apparatus disclosed in Patent Document 1 conveys a test chart in advance and calculates a difference between actual position information of a mark actually detected by a two-dimensional sensor when a conveyor roller makes one revolution and theoretical position information of the mark ideally detected by the two-dimensional sensor. The recording apparatus controls an amount of conveyance of the conveyor roller by calculating a corrected amount of feed of each mark from an actual amount of feed of each mark obtained by the two-dimensional sensor detecting the mark based on the calculated difference.

However, a process of conveying the test chart in advance is necessary in the recording apparatus of Japanese Laid-open Patent Publication No. 2011-131399, and this is cumbersome. Furthermore, vibration at the conveyance of the test chart is transmitted to a recording medium in the recording apparatus of Patent Document 1. Therefore, the two-dimensional sensor detects a position of the test chart displaced by the vibration and detects an amount of conveyance different from the amount of conveyance of the test chart actually conveyed. It is difficult to detect an amount of conveyance with an excellent accuracy.

### Patent Document 1

Japanese Laid-Open Patent Publication No. 2011-131399

### SUMMARY OF THE INVENTION

The present invention has been made in view of the problems, and an object of the present invention is to enable detecting highly accurate conveyance information.

The present invention provides a conveyance detection apparatus of a conveying apparatus, the conveying apparatus including: a conveying unit that conveys a conveyed object along a conveyance path; and an imaging unit that images the conveyed object and an object not conveyed by the conveying unit, the conveyance detection apparatus including a conveyance detection unit that acquires actual conveyance information of the conveyed object from image information of the conveyed object imaged by the imaging unit and image information of the object imaged by the imaging unit.

The present invention provides a conveying apparatus including: a conveying unit that conveys a conveyed object along a conveyance path; an imaging unit that images the conveyed object and an object not conveyed by the conveying unit; a conveyance detection unit that acquires actual conveyance information of the conveyed object from image information of the conveyed object imaged by the imaging unit and image information of the object imaged by the imaging unit; and a housing that houses the conveying unit, the imaging unit, and the object.

The present invention provides a recording apparatus including: a conveying unit that conveys a conveyed object along a conveyance path; an imaging unit that images the conveyed object and an object not conveyed by the conveying unit; a conveyance detection unit that acquires actual conveyance information of the conveyed object from image information of the conveyed object imaged by the imaging unit and image information of the object imaged by the imaging unit; and a recording unit that records an image on the conveyed object based on conveyance information detected by the conveyance detection unit.

### BRIEF DESCRIPTION OF THE DRAWINGS

FIG. 1 is a view illustrating a schematic configuration of a recording apparatus 100;

FIG. 2 is a view illustrating a configuration of part of a conveying unit 10 as viewed from an imaging unit 30;

FIG. 3 is a block diagram illustrating an internal configuration of the recording apparatus 100;

FIG. 4 is a flow chart illustrating a process by a control unit 50;

FIG. 5 is a flow chart illustrating a process by the control unit 50;

FIG. 6 is a view illustrating an example of first image data 60 imaged by the imaging unit 30; and

FIG. 7 is a view illustrating an example of second image data 70 imaged by the imaging unit 30.

### DETAILED DESCRIPTION OF THE PREFERRED EMBODIMENTS

An embodiment of the present invention will now be described in detail with reference to the drawings.

The present embodiment provides a conveyance detection apparatus and a conveying apparatus or a recording apparatus including the conveyance detection apparatus. The conveyance detection apparatus detects conveyance information of a conveyed object. The conveying apparatus conveys the conveyed object based on the conveyance information of the conveyed object detected by the conveyance detection apparatus. The recording apparatus forms an image on the conveyed object, specifically, recording paper, detected by the conveyance detection apparatus based on the conveyance information of the recording paper and records the image.

In the following drawings, a conveyance direction of the conveyed object will be expressed as an X direction, a direction orthogonal to the X direction and parallel to a conveyed surface will be expressed as a Y direction, and a direction orthogonal to the conveyed surface will be expressed as a Z direction, as necessary. The side of a paper feeding opening 14 described later in the conveyance direction will be called an upstream, and the side of a paper discharge opening 15 described later will be called a downstream.

### First Embodiment

A recording apparatus 100 according to the present embodiment is applied to an inkjet type printer in the following description.

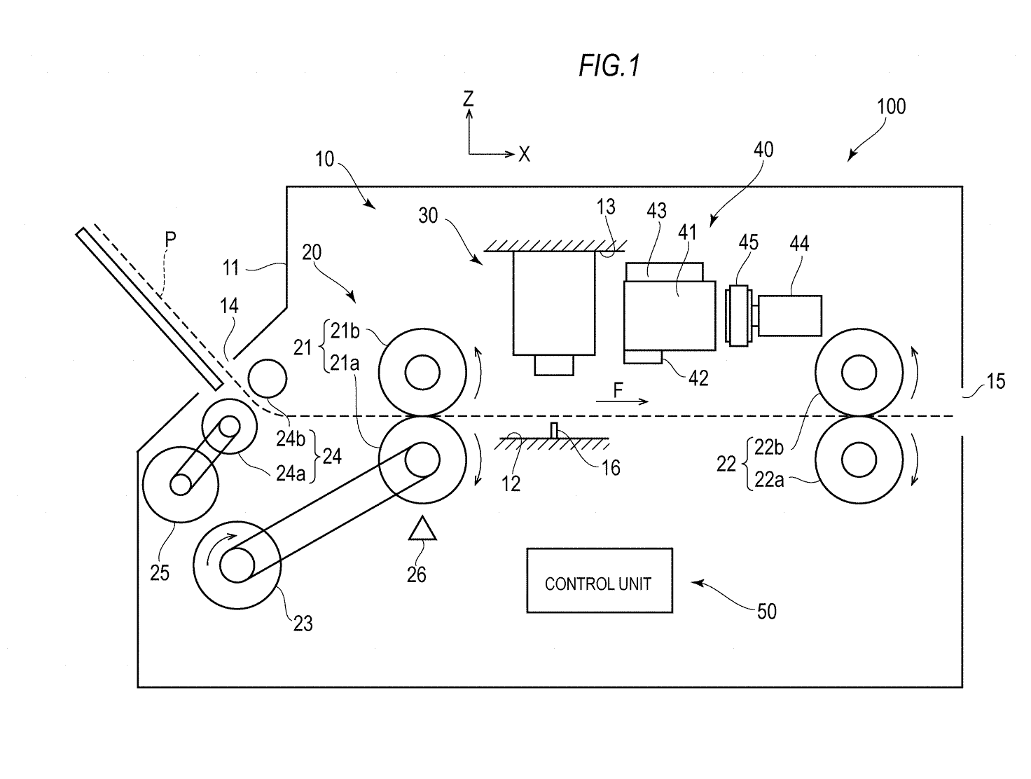

FIG. 1 is a view illustrating a schematic configuration of the recording apparatus 100.

The recording apparatus 100 includes a conveying apparatus 10, a recording unit 40, and a control unit 50 that controls operation of the conveying apparatus 10 and the recording unit 40.

The conveying apparatus 10 conveys a recording medium (hereinafter, called recording paper P) as a fed conveyed object along a conveyance path and discharges the recording medium after the recording medium passes through the recording unit 40. The conveying apparatus 10 includes a housing 11, a conveying unit 20, and an imaging unit 30.

The housing 11 houses and supports constituent members of the recording apparatus 100. The housing 11 includes a conveyance support portion 12 that supports the conveying unit 20 and an imaging support portion 13 that supports the imaging unit 30. The housing 11 also includes the paper feeding opening 14 for feeding the recording paper P and the paper discharge opening 15 for discharging the recording paper P. The housing 11 also includes an imaging reference portion described later.

The conveying unit 20 conveys the recording paper P. The conveying unit 20 includes a first conveyor roller unit 21 and a second conveyor roller unit 22 as rotating bodies, a conveyor motor 23, a paper feeding roller unit 24, a paper feeding motor 25, and an encoder 26.

The first conveyor roller unit 21 includes a pair of rollers 21a and 21b and conveys the recording paper P placed between the rollers 21a and 21b. Similarly, the second conveyor roller unit 22 includes a pair of rollers 22a and 22b and conveys the recording paper P placed between the rollers 22a and 22b. The first conveyor roller unit 21 and the second conveyor roller unit 22 are rotatably supported by the conveyance support portion 12 of the housing 11 at positions separated in the conveyance direction. Therefore, a conveyance path of the recording paper P is formed between the pair of rollers 21a and 21b and between the pair of rollers 22a and 22b (the recording paper P and the conveyance path overlap in FIG. 1). The conveyor motor 23 rotates the first conveyor roller unit 21 and the second conveyor roller unit 22. Therefore, the drive of the conveyor motor 23 conveys the recording paper P placed between the pair of rollers 21a and 21b and the pair of rollers 22a and 22b in the conveyance direction (arrow F illustrated in FIG. 1). The paper feeding roller unit 24 includes a pair of rollers 24a and 24b and places the recording paper P between the rollers 24a and 24b. The paper feeding roller unit 24 separates each of a plurality of pieces of recording paper P loaded on a tray and feeds the recording paper P from the paper feeding opening 14. The paper feeding motor 25 rotates the paper feeding roller unit 24. Therefore, the paper feeding motor 25 rotates to feed the recording paper P placed between the pair of rollers 24a and 24b from the paper feeding opening 14. The encoder 26 detects a rotation state by reading a slit along a circumference of a code wheel not illustrated of the first conveyor roller unit 21 and transmits the detected information to the control unit 50.

The conveying unit 20 may be configured to bring the recording paper P into close contact with a conveyor belt to convey the recording paper P instead of conveying the recording paper P by the pairs of rollers.

The imaging unit 30 two-dimensionally images the surface of the recording paper P being conveyed by the conveying unit 20. More specifically, the imaging unit 30 is supported by the imaging support portion 13 of the housing 11 such that a direction orthogonal to the surface of the recording paper P is an imaging direction. The imaging unit 30 can include a lens and an image sensor including an image pickup element. The imaging unit 30 is arranged on the upstream of the recording unit 40 in the conveyance direction, and the imaging unit 30 images the surface of the recording paper P before the image is recorded by the recording unit 40. The imaging unit 30 transmits the taken image information to the control unit 50.

In addition to the recording paper P being conveyed, an imaging range of the imaging unit 30 of the present embodiment includes an object other than the recording paper P.

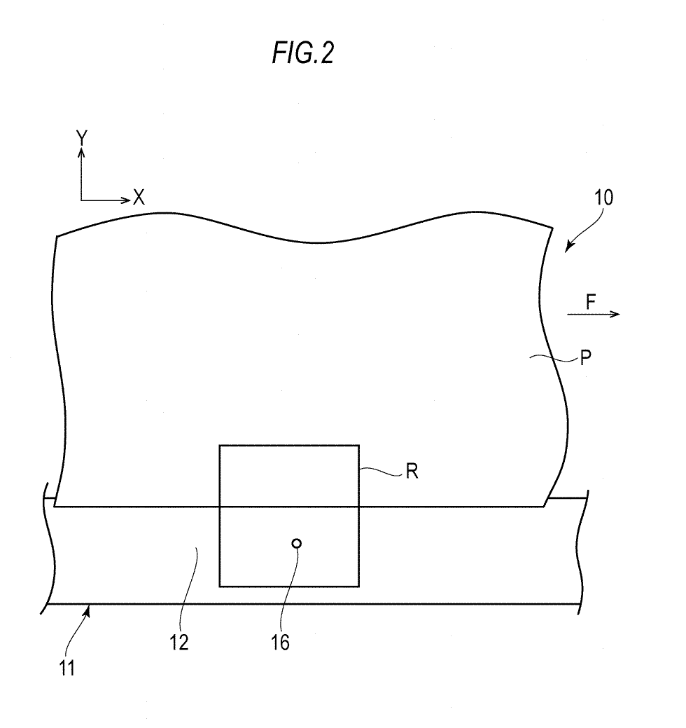

FIG. 2 is a view illustrating a configuration of part of the conveying apparatus 10 as viewed from the imaging unit 30, and an imaging range R of the imaging unit 30 is indicated. The imaging range R includes the recording paper P conveyed along the conveyance path and the object other than the recording paper P, that is, an object not conveyed by the conveying unit 20. The object not conveyed by the conveying unit 20 is, for example, the housing 11, and members integrated and coupled to the housing 11 are also included. Therefore, the imaging range R is set such that the imaging unit 30 can simultaneously image the recording paper P that moves in the conveyance direction along with the conveyance of the conveying unit 20 and the housing 11 that does not move in the conveyance direction. The imaging range R can include, for example, 1024 pixels×1024 pixels. Assuming that a pitch of one pixel is, for example, 10 μm here, the imaging range R is 10.24 mm×10.24 mm. The imaging range R can be set to a size according to an amount of conveyance.

Meanwhile, the housing 11 includes a reference member 16 as an imaging reference portion in the imaging range R. The reference member 16 is a pin-like member or a rod-like member and is supported by the conveyance support portion 12 of the housing 11. The reference member 16 protrudes toward the imaging unit 30 from the conveyance support portion 12. Therefore, the imaging unit 30 images a tip of the reference member 16. Here, a distance from the imaging unit 30 to the recording paper P conveyed in the conveyance path and a distance from the imaging unit 30 to the reference member 16 are set to substantially the same distance. The reference member 16 can be, for example, a pin with a diameter of about 20 pixels. Assuming that the pitch of one pixel is, for example, 10 μm here, the diameter of the reference member 16 is 0.2 mm.

The recording unit 40 records an image or the like on the surface of the conveyed recording paper P. The recording unit 40 is arranged on the downstream of the imaging unit 30 in the conveyance direction and is configured to record the image on the recording paper P after the image is taken by the imaging unit 30. The recording unit 40 includes a carriage 41, a recording head 42, an ink tank 43, and a carriage moving motor 44. The carriage 41 is driven by the carriage moving motor 44 to move back and forth in the direction orthogonal to the conveyance direction of the recording paper P and parallel to the surface of the recording paper P, that is, in the Y direction. The recording head 42 discharges ink from a nozzle toward the surface of the recording paper P in conjunction with the backward and forward movement of the carriage 41. The ink tank 43 supplies stored ink to the recording head 42. The carriage moving motor 44 moves the carriage 41 back and forth through a belt 45.

The recording unit 40 is not limited to the inkjet type, and an electrophotographic type, a thermal transfer type, a dot impact type or the like may also be adopted.

The control unit 50 controls the conveying apparatus 10 and the recording unit 40. Specifically, the control unit 50 alternately repeats instructing the conveying apparatus 10 to convey the recording paper P with an amount of conveyance for one step and instructing the recording unit 40 to discharge the ink from the nozzle of the recording head 42 to record an image for one step. Therefore, a process by the conveying apparatus 10 conveying the recording paper P for one step and a process by the recording unit 40 recording an image for one step are repeated in the recording apparatus 100 to record a desired image on the entire surface of the recording paper P.

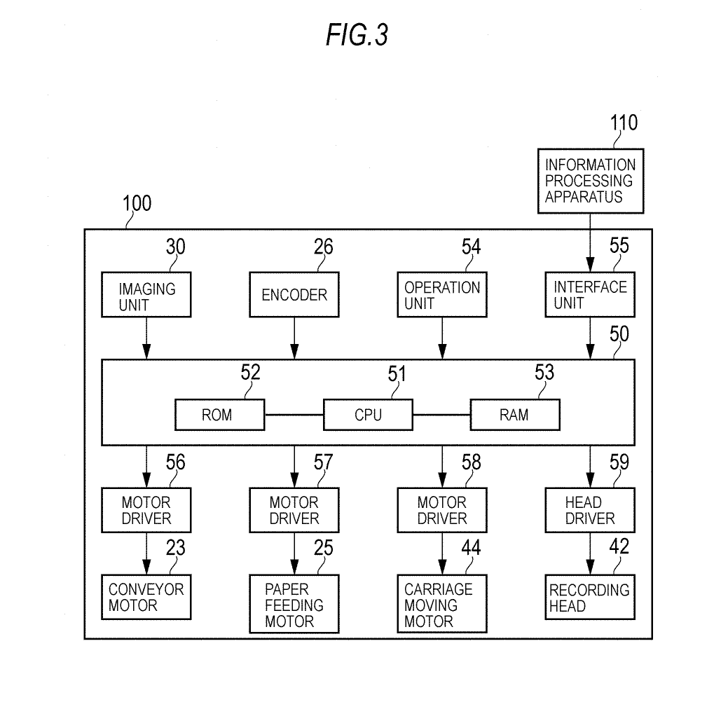

FIG. 3 is a block diagram illustrating an internal configuration of the recording apparatus 100 with a focus on the control unit 50.

The control unit 50 includes a CPU 51, a ROM 52, and a RAM 53 and functions as a so-called computer.

The CPU 51 expands a program stored in the ROM 52 to the RAM 53 and executes the program to control the entire recording apparatus 100. The program and data necessary for a process by the CPU 51 are stored in the ROM 52. The RAM 53 is a memory that temporarily stores information when the CPU 51 executes the process.

The control unit 50 is connected to the imaging unit 30, the encoder 26, an operation unit 54, and an information processing apparatus 110 and is configured to receive information from them. A user operates the operation unit 54 to issue an instruction to the control unit 50. Examples of the operation unit 54 include a switch, a button, and a touch panel. Examples of the information processing apparatus 110 include a PC, a smartphone, and a tablet terminal, and the information processing apparatus 110 is connected in a wireless or wired manner through an interface unit 55.

The control unit 50 is connected to the conveyor motor 23, the paper feeding motor 25, the carriage moving motor 44, and the recording head 42 through motor drivers 56, 57, and 58 and a head driver 59, respectively, and is configured to transmit information to them.

In the recording apparatus 100 configured as described above, the imaging unit 30 images, at different timings, the recording paper P being conveyed and transmits the taken image information to the control unit 50. Based on two pieces of image information taken at different timings, the control unit 50 uses pattern matching to detect actual conveyance information of the recording paper P, specifically, a distance conveyed in the X direction and a distance conveyed in the Y direction (distance displaced in the Y direction). Therefore, the control unit 50 functions as a conveyance detection apparatus that detects conveyance information. The control unit 50 also controls the recording head 42 to discharge the ink according to the detected actual conveyance information. Therefore, the recording unit 40 can record an image without a break and without an overlap.

However, the conveyor motor 23 of the conveying unit 20 is configured to rotate the first conveyor roller unit 21 and the like to convey the recording paper P in the recording apparatus 100, and vibration of the conveyor motor 23 and vibration during the rotation of the first conveyor roller unit 21 are transmitted to the recording paper P. The vibration assumed here has a frequency of 30 Hz, a width of 40 μm, and an amplitude of 20 μm, for example.

Furthermore, the conveyance support portion 12 that supports the conveying unit 20 and the imaging support portion 13 that supports the imaging unit 30 are different in the recording apparatus 100. Therefore, the vibration from the conveying unit 20 is transmitted to the imaging unit 30 in a different phase or is attenuated. More specifically, there is a phase difference between the vibration of the recording paper P and the vibration of the imaging unit 30. Therefore, the image of the recording paper P taken by the imaging unit 30 includes an error caused by the vibration of the recording paper P, and the control unit 50 may not be able to detect highly accurate conveyance information.

Thus, the imaging unit 30 simultaneously images the reference member 16 in addition to the recording paper P being conveyed in the present embodiment. The image information of the recording paper P includes information in which the effect of the vibration is added to the actual conveyance information. On the other hand, the image information of the reference member 16 includes information of only the effect of the vibration, because the reference member 16 is not conveyed. Therefore, the control unit 50 can remove the effect of the vibration included in the image information of the reference member 16 from the image information of the recording paper P to detect the actual conveyance information of the recording paper P.

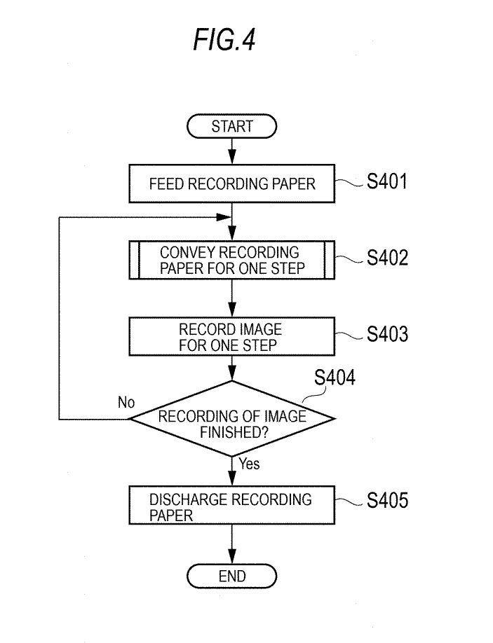

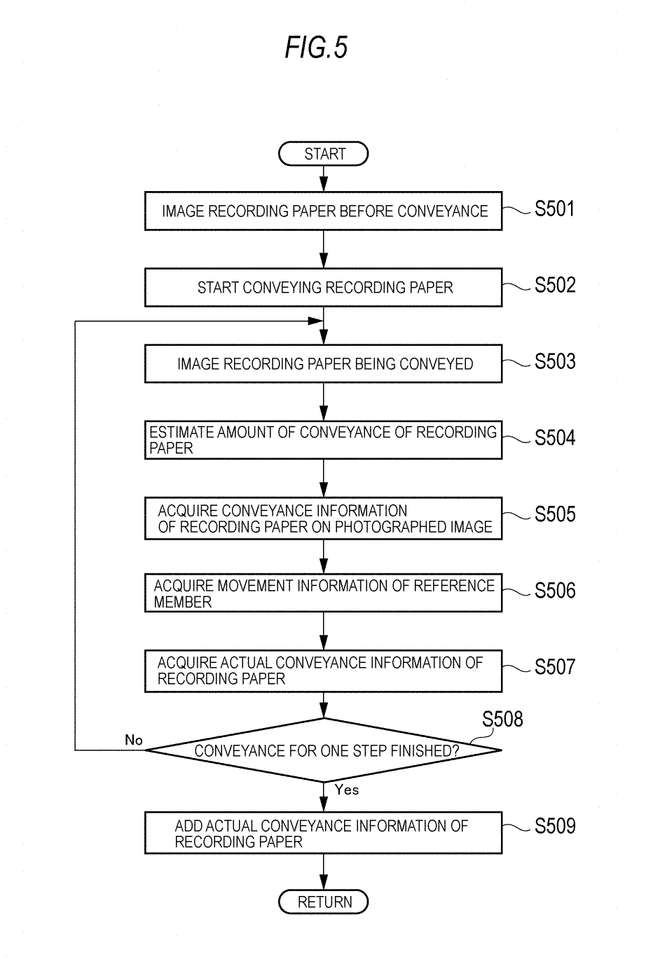

Hereinafter, a specific process by the control unit 50 will be described with reference to flow charts of FIGS. 4 and 5. The CPU 51 of the control unit 50 expands a program stored in the ROM 52 to the RAM 53 and executes the program to realize the flow charts of FIGS. 4 and 5.

In S401, the control unit 50 drives the paper feeding motor 25 to rotate the paper feeding roller unit 24 and separates each of the plurality of pieces of recording paper P loaded on the tray to feed the recording paper P from the paper feeding opening 14. The control unit 50 further sets a desired position for the recording paper P and drives the conveyor motor 23 to convey the recording paper P to a recording start position.

In S402, the control unit 50 drives the conveyor motor 23 to convey the recording paper P for one step. Based on the image information taken by the imaging unit 30, the control unit 50 also detects the conveyance information of the recording paper P actually conveyed at the conveyance of the recording paper P for one step, more specifically, the distance conveyed in the X direction and the distance conveyed in the Y direction. Details of the process will be described later with reference to the flow chart of FIG. 5.

In S403, the control unit 50 drives the carriage moving motor 44 to move the carriage 41 and discharges the ink from the nozzle of the recording head 42 to record the image for one step in which the recording paper P is conveyed.

In this case, the control unit 50 controls the recording head 42 to discharge the ink according to the detected actual conveyance information. Specifically, based on the actual distance conveyed in the X direction, the control unit 50 records the image throughout a region equivalent to the distance conveyed in the X direction. For example, when the distance actually conveyed is longer than the original amount of conveyance in the X direction, the image is recorded for a region including the extra length in the X direction. The control unit 50 also makes an offset equivalent to the distance conveyed in the Y direction (distance displaced in the Y direction) and records the image. Although the conveying unit 20 is not ordinarily supposed to convey the recording paper P in the Y direction, the recording paper P may be displaced in the Y direction due to slipping of the conveyor roller unit or the like. In this case, the control unit 50 records the image by shifting the timing of the start of the discharge of the ink according to the distance conveyed in the Y direction when the control unit 50 moves the recording head 42 in the Y direction.

In S404, the control unit 50 determines whether all of the recording of the image is finished. If all of the recording of the image is finished, the control unit 50 proceeds to step S405. If all of the recording of the image is not finished, the control unit 50 returns to S402 to repeat the process of S402 and S403.

In S405, the control unit 50 drives the conveyor motor 23 to discharge the recording paper P with the recorded image from the paper discharge opening 15.

Next, the process of S402 will be described with reference to the flow chart of FIG. 5.

In S501, the control unit 50 instructs the imaging unit 30 to take an image before the recording paper P is conveyed from the recording start position. The imaging unit 30 takes an image including the recording paper P and the reference member 16 in the imaging range R and transmits the taken image information, that is, image data, to the control unit 50. The control unit 50 applies image processing, such as shading correction, to the received image data and stores the image data after the image processing. In this case, the control unit 50 stores the image data after adding identification information to the image data. For the convenience, the stored image data will be called first image data.

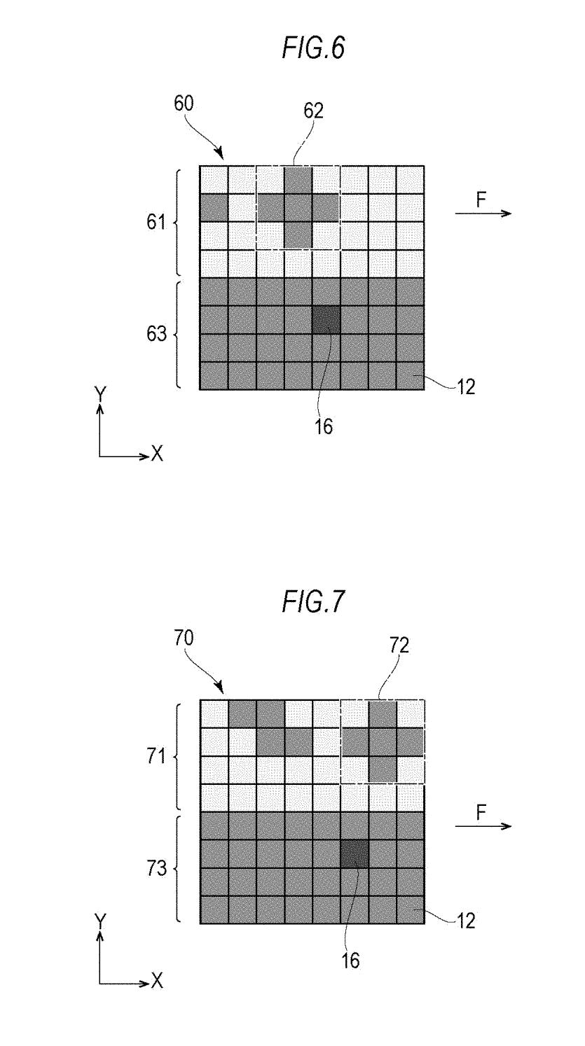

FIG. 6 is a view illustrating an example of first image data 60 obtained by the imaging unit 30 photographing the imaging range R. Each rectangle in the first image data 60 illustrated in FIG. 6 indicates one pixel of the image pickup element of the imaging unit 30. To facilitate the understanding, it is assumed here that the imaging range R is a range of 8 pixels×8 pixels, and the image is a gray scale image with 256 black and white gradations.

As illustrated in FIG. 6, a paper image 61 in the first image data 60 is an image obtained by photographing the recording paper P and is an example of the image information of the conveyed object. The recording paper P is not recorded yet, and the brightness value of the paper image 61 as a whole is high. However, the brightness value varies with respect to the average brightness of the entire recording paper P due to slight unevenness on the surface of the recording paper P, and the unevenness emerges as a pattern. The control unit 50 extracts an image of a predetermined region (region in an alternate long and short dash line) as a template image 62 and stores brightness information and position information. For example, the control unit 50 stores the brightness value of each pixel in the template image 62 and the center coordinates of the template image 62 in the first image data 60. In FIG. 6, the center coordinates of the template image 62 are (X, Y)=(4, 7).

Meanwhile, a region of a housing image 63 in the first image data 60 is an image obtained by photographing the conveyance support portion 12 and the reference member 16 of the housing 11 and is an example of the image information of the imaging reference portion. Although the brightness value of the conveyance support portion 12 is substantially constant in the housing image 63, the brightness value of the reference member 16 is lower than the conveyance support portion 12. The control unit 50 specifies, as the reference member 16, a pixel with a brightness value substantially the same as a brightness value stored in advance and stores the specified position information. For example, the center coordinates of the reference member 16 are (X, Y)=(5, 3) in FIG. 6.

Although the brightness value of the reference member 16 used here is higher than the brightness value of the conveyance support portion 12, a reference member 16 with a brightness value lower than the brightness value of the conveyance support portion 12 may be used instead.

In S502, the control unit 50 instructs the conveyor motor 23 to start conveying the recording paper P by an amount of conveyance for one target step (hereinafter, called a target amount of conveyance). Therefore, the conveyor motor 23 rotates the first conveyor roller unit 21 to convey the recording paper P for the target amount of conveyance.

In S503, the control unit 50 instructs the imaging unit 30 to image the recording paper P being conveyed. The imaging unit 30 takes an image including the recording paper P being conveyed and the reference member 16 in the same imaging range R as in S501 and transmits the taken image data to the control unit 50. The control unit 50 applies image processing, such as shading correction, to the received image data and stores the image data after the image processing. In this case, the control unit 50 stores the image data after adding identification information to the image data. For the convenience, the stored image data will be called second image data here.

FIG. 7 is a view illustrating an example of second image data 70 obtained by the imaging unit 30 photographing the imaging range R. As illustrated in FIG. 7, a region of a paper image 71 in the second image data 70 indicates a photographed image obtained by photographing the recording paper P being conveyed. In the paper image 71, a region equivalent to the template image 62 of the first image data 60 is moved in the conveyance direction.

Meanwhile, a region of a housing image 73 in the second image data 70 indicates a photographed image obtained by imaging the reference member 16. Although the reference member 16 is supported by the conveyance support portion 12 and is not conveyed, the reference member 16 is moved due to the vibration of the first conveyor roller unit 21.

Here, the timing of imaging in S503 is set in a time period (predetermined time) in which the second image data 70 includes the region equivalent to the template image 62 of the first image data 60. The predetermined time is stored in advance in the control unit 50 based on the imaging range R and the conveyance speed.

In S504, the control unit 50 estimates an amount of conveyance of the recording paper P between the imaging of the last time and the imaging of this time. Specifically, the control unit 50 calculates the amount of conveyance of the recording paper P (hereinafter, called an estimated amount of conveyance) from the information detected by the encoder 26. The estimated amount of conveyance is detected based on the amount of rotation of the first conveyor roller unit 21 and is different from the actual amount of conveyance of the recording paper P when the first conveyor roller unit 21 is decentered or when there is slipping between the first conveyor roller unit 21 and the recording paper P. The control unit 50 stores the calculated estimated amount of conveyance.

Next, in a process from S505 to S507, the control unit 50 detects the actual conveyance information of the recording paper P in which the effect of the vibration is removed, based on the image information of the recording paper P and the image information of the reference member 16. The process is an example of the process by the conveyance detection unit.

In S505, the control unit 50 acquires conveyance information of the recording paper P on the photographed image from the image information of the recording paper P in the first image data 60 and the image information of the recording paper P in the second image data 70. The process is an example of the process by the conveyance information acquisition unit.

Specifically, the control unit 50 acquires the conveyance information of the recording paper P on the photographed image by searching the position of the pattern image, which is similar to the template image 62 extracted from the paper image 61 of the first image data 60, in the paper image 71 of the second image data 70.

Here, a pattern matching method can be used as a method of searching the position of the pattern image similar to the template image 62. As illustrated in FIG. 7, the control unit 50 uses, for example, SAD (Sum of Absolute Difference) to search the pattern image similar to the template image 62 from the paper image 71 of the second image data 70 based on the brightness information of each image. In this case, the control unit 50 can quickly perform the pattern matching by searching only the proximity of the estimated amount of conveyance based on the estimated amount of conveyance calculated in S504. The control unit 50 specifies a pattern image 72 most similar to the template image 62 in the paper image 71 and acquires the position information of the specified pattern image 72. In FIG. 7, the coordinates (center coordinates) of the pattern image 72 are (X, Y)=(7, 7).

Next, the control unit 50 calculates the conveyance information on the photographed image by obtaining the difference in the X direction and the difference in the Y direction from the coordinates of the template image 62 of the paper image 61 of the first image data 60 and the coordinates of the specified pattern image 72. In FIGS. 6 and 7, the control unit 50 can acquire the conveyance information on the taken image indicating that the recording paper P is conveyed +3 pixels in the X direction and 0 pixels in the Y direction based on the difference in the coordinates. The control unit 50 stores the acquired conveyance information on the photographed image.

In S506, the control unit 50 acquires movement information of the reference member 16 on the photographed image from the image information of the reference member 16 in the first image data 60 and the image information of the reference member 16 in the second image data 70. The process is an example of the process by the movement information acquisition unit. The reference member 16 is not conveyed, and the movement information here indicates movement caused by the vibration of the first conveyor roller unit 21 or the like.

Specifically, the control unit 50 specifies, as the reference member 16, the pixel with substantially the same brightness value as the brightness value stored in advance and acquires the specified position information. For example, the center coordinates of the reference member 16 are (X, Y)=(6, 3) in FIG. 7. To specify the reference member 16, a method similar to the method of searching the pattern image similar to the template image 62 can be used. In this case, the control unit 50 can quickly perform the pattern matching by searching only a range of amplitude of vibration supposed in advance.

Next, the control unit 50 calculates the movement information of the reference member 16 on the photographed image by obtaining the difference in the X direction and the difference in the Y direction from the coordinates of the reference member 16 of the housing image 63 of the first image data 60 and the coordinates of the reference member 16 specified in the housing image 73 of the second image data 70. For example, in FIGS. 6 and 7, the control unit 50 can acquire the movement information on the taken image indicating that the reference member 16 is moved +1 pixel in the X direction and 0 pixels in the Y direction based on the difference in the coordinates. The control unit 50 stores the acquired movement information on the photographed image.

In step S507, the control unit 50 corrects the conveyance information of the recording paper P on the photographed image based on the image information of the reference member 16 on the photographed image to detect the actual conveyance information of the recording paper P in which the effect of the vibration is removed. The process is an example of the process by the correction unit.

Specifically, the control unit 50 can subtract the pixel after the movement of the reference member 16 in the X direction and the Y direction on the photographed image from the pixel after the conveyance of the recording paper P in the X direction and the Y direction in the photographed image to calculate the actual conveyance information of the recording paper P.

In FIGS. 6 and 7, the conveyance information of the recording paper P on the photographed image is information indicating +3 pixels in the X direction and 0 pixels in the Y direction, and the movement information of the reference member 16 on the photographed image is information indicating +1 pixel in the X direction and 0 pixels in the Y direction. Therefore, the control unit 50 subtracts 1 pixel from 3 pixels in the X direction and subtracts 0 pixels from 0 pixels in the Y direction to obtain +2 pixels in the X direction and 0 pixels in the Y direction. Thus, the calculated conveyance information is the actual conveyance information of the recording paper P in which the effect of the vibration is removed, and the recording paper P here is actually conveyed +2 pixels in the X direction and 0 pixels in the Y direction in the imaging timing from the first image data 60 to the second image data 70. The control unit 50 stores the acquired conveyance information of the recording paper P actually conveyed.

In S508, the control unit 50 determines whether the conveyance equivalent to one step is finished. If the conveyance equivalent to one step is not finished, the control unit 50 returns to S503 to repeat the process from S503 to S507. In this case, the control unit 50 sets, as the second image data, new image data acquired by returning to S503 and sets, as the first image data, the image data acquired in S503 of the last time to execute the process from S505 to S507. More specifically, in S503, it is preferable that the control unit 50 extracts the predetermined region as the template image 62 as in S501 and stores the brightness information and the position information, in addition to the storage of the image data after the image processing.

On the other hand, if the conveyance equivalent to one step is finished, the control unit 50 proceeds to S509. The control unit 50 proceeds to S509 when the conveyance is temporarily halted for the recording of the image by the recording unit 40 after the end of the conveyance equivalent to one step.

In S509, the control unit 50 adds all the actual conveyance information stored in S507 to acquire the conveyance information of the recording paper P actually conveyed in the conveyance for one step. Specifically, the control unit 50 adds the pixels in the X direction and the Y direction and multiplies the added pixels by the pixel pitch to acquire the distance conveyed in the X direction and the distance conveyed in the Y direction.

In this way, the control unit 50 can acquire the conveyance information of the recording paper P actually conveyed in the conveyance for one step to control the recording head 42 according to the detected actual conveyance information to discharge the ink in S403. Therefore, the control unit 50 records the image throughout the region equivalent to the distance conveyed in the X direction based on the actual distance conveyed in the X direction and records the image after offsetting the image according to the distance displaced in the Y direction. This can prevent a broken image and an overlapped image even when the recording unit 40 records the image step by step.

According to the present embodiment, the control unit 50 detects the conveyance information of the recording paper P based on the image information of the recording paper P and the image information of the object not conveyed imaged by the imaging unit 30. Here, the image information of the recording paper P includes information in which the effect of the vibration is added to the actual conveyance information, and the image information of the object not conveyed includes information of only the effect of the vibration. Therefore, the effect of the vibration included in the image information of the object not conveyed can be removed from the image information of the recording paper P to accurately detect the actual conveyance information of the recording paper P.

According to the present embodiment, the control unit 50 detects the conveyance information of the recording paper P based on the image information of the recording paper P and the image information of the reference member 16 imaged by the imaging unit 30. Here, the reference member 16 can be easily specified from the image information by using the reference member 16 as an object not conveyed, and the information of the effect of the vibration can be accurately detected from the image information of the reference member 16.

According to the present embodiment, the housing 11 includes the conveyance support portion 12 that supports the conveying unit 20, and the conveyance support portion 12 directly or indirectly supports the reference member 16. Thus, the vibration of the first conveyor roller unit 21 or the second conveyor roller unit 22 of the conveying unit 20 is transmitted to the reference member 16 without a phase difference. Therefore, the effect of substantially the same vibration can be included in both the image information of the recording paper P and the image information of the reference member 16, and the effect of the vibration included in the image information of the reference member 16 can be easily removed from the image information of the recording paper P.

According to the present embodiment, the control unit 50 detects the actual conveyance information of the recording paper P by correcting the conveyance information of the recording paper P acquired based on the image information of the recording paper P, based on the movement information of the reference member 16 acquired based on the image information of the reference member 16. Here, the conveyance information of the recording paper P includes the information in which the effect of the vibration is added to the actual conveyance information, and the movement information of the reference member 16 includes the information of only the effect of the vibration. Therefore, the effect of the vibration can be removed from the conveyance information of the recording paper P by correcting the movement information of the reference member 16, and the actual conveyance information of the recording paper P can be accurately detected.

According to the present embodiment, the control unit 50 acquires the conveyance information of the recording paper P on the photographed image based on the image information before and after the predetermined time in the recording paper P and acquires the movement information of the reference member 16 on the photographed image based on the image information before and after the predetermined time in the reference member 16. The control unit 50 uses the movement information on the photographed image to correct the conveyance information on the photographed image to thereby detect the actual conveyance information of the recording paper P. Therefore, the actual conveyance information of the recording paper P can be accurately detected.

According to the present embodiment, the recording paper P and the reference member 16 are imaged in the same imaging range R, and the image information of the recording paper P and the image information of the reference member 16 are acquired from the same photographed image. Therefore, a plurality of imaging units 30 with synchronized imaging timing do not have to be provided, and the cost of the conveying apparatus 10 can be reduced.

According to the present embodiment, the distance from the imaging unit 30 to the conveyance path and the distance from the imaging unit 30 to the reference member 16 are substantially the same. Therefore, a focused image can be easily taken for both the image information of the recording paper P and the image information of the reference member 16 imaged by the imaging unit 30. However, the distance from the imaging unit 30 to the conveyance path and the distance from the imaging unit 30 to the reference member 16 may not be the same if a focused image can be taken.

According to the present embodiment, the reference member 16 is a rod-like member protruding toward the imaging unit 30. Therefore, the imaging reference portion can be easily set. In this case, the distance from the imaging unit 30 to the conveyance path and the distance from the imaging unit 30 to the tip of the rod-like member are substantially the same. Therefore, a focused image can be easily taken for both the image information of the recording paper P and the image information of the rod-like member imaged by the imaging unit 30. However, the reference member 16 is not limited to the rod-like member, and the reference member 16 may be a light source such as an LED.

Although the present invention has been described with reference to the embodiment, the present invention is not limited to the embodiment, and changes can be made within the scope of the present invention.

In the case described in the embodiment, the process from S503 to S507 is repeated, and the conveyance information of the recording paper P actually conveyed for one step is acquired in S509. The recording unit 40 records the image based on the acquired conveyance information. However, the present invention is not limited to this. For example, the actual conveyance information may be acquired in S507, and the acquired actual conveyance information may be fed back to control the conveyor motor 23 in real time. More specifically, the control unit 50 controls the conveyor motor 23 to reduce the amount of rotation when the acquired actual conveyance information is long and controls the conveyor motor 23 to increase the amount of rotation when the acquired actual conveyance information is short. Therefore, when the conveyance for one step is finished, the same amount of conveyance as the scheduled amount of conveyance for one step can be conveyed. As a result of the control, the recording unit 40 only has to always record the image for one step, and the control unit 50 can reduce the control for the recording unit 40. As a result of the control, the printer is not limited to the inkjet type in which the image is recorded step by step, and a printer of an electrophotographic type, a thermal transfer type, a dot impact type, or the like can also be used. As a result of the control, not only the recording apparatus 100, but also a conveying apparatus without the configuration of the recording unit 40 can be adopted. Note that an example of the conveying apparatus 10 includes an image reading apparatus, such as a scanner, in which the configuration of the recording unit 40 is replaced with a configuration of an image reading unit.

Although the reference member 16 is directly supported by the conveyance support portion 12 in the case described in the embodiment, the present invention is not limited to the case, and the reference member 16 may be indirectly supported by the conveyance support portion 12 through an intermediate member. More specifically, it is only necessary that the reference member 16 is supported at a position in which the vibration of the conveying unit 20 is transmitted without a phase difference. On the other hand, the imaging unit 30 may be supported at a position with a phase difference relative to the vibration of the conveying unit 20, and the installation position of the imaging unit 30 can be freely set.

Although the control unit 50 is arranged in the housing 11 in the case described in the present embodiment, the present invention is not limited to the case, and the control unit 50 may be arranged outside of the housing 11. In this case, the control unit 50 can control the conveying apparatus 10 and the recording unit 40 in a wired or wireless manner.

Although the CPU 51 executes the program to realize the process in the case described in the present embodiment, the present invention is not limited to the case, and each circuit including hardware may execute the process.

The present invention also includes the program and a computer-readable recording medium recording the program.

According to the present invention, highly accurate conveyance information can be detected.

It should be noted that the above embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

What is claimed is:

1. A conveyance detection apparatus of a conveying apparatus, the conveying apparatus comprising:
a conveying unit that conveys a conveyed object along a conveyance path; and
an imaging unit that images the conveyed object and an object not conveyed by the conveying unit, the conveyance detection apparatus comprising
a conveyance detection unit that acquires actual conveyance information of the conveyed object from image information of the conveyed object imaged by the imaging unit and image information of the object imaged by the imaging unit.

2. The conveyance detection apparatus of the conveying apparatus according to claim 1, wherein
the object is an imaging reference portion arranged at a position separated from the conveyance path, and
the conveying apparatus comprises a housing that houses the conveying unit, the imaging unit, and the imaging reference portion.

3. The conveyance detection apparatus of the conveying apparatus according to claim 2, wherein
the housing comprises an imaging support portion that supports the imaging unit and a conveyance support portion that supports the conveying unit, and
the conveyance support portion directly or indirectly supports the imaging reference portion.

4. The conveyance detection apparatus of the conveying apparatus according to claim 2, wherein
the conveyance detection unit uses movement information of the imaging reference portion acquired from image information of the imaging reference portion to correct conveyance information of the conveyed object acquired from the image information of the conveyed object to thereby acquire the actual conveyance information of the conveyed object.

5. The conveyance detection apparatus of the conveying apparatus according to claim 2, wherein
the conveyance detection unit comprises:
a conveyance information acquisition unit for acquiring the conveyance information of the conveyed object from the image information of the conveyed object before and after a predetermined time;
a movement information acquisition unit for acquiring the movement information of the imaging reference portion from the image information of the imaging reference portion before and after the predetermined time; and
a correction unit for using the movement information to correct the conveyance information to thereby acquire the actual conveyance information of the conveyed object.

6. The conveyance detection apparatus of the conveying apparatus according to claim 2, wherein
the imaging unit images the conveyed object and the imaging reference portion in a same imaging range, and
the conveyance detection unit acquires the image information of the conveyed object and the image information of the imaging reference portion from a same photographed image taken by the imaging unit.

7. The conveyance detection apparatus of the conveying apparatus according to claim 2, wherein
the imaging unit images the conveyance path and the imaging reference portion in the same imaging range, and
a distance from the imaging unit to the conveyance path and a distance from the imaging unit to the imaging reference portion are substantially the same.

8. The conveyance detection apparatus of the conveying apparatus according to claim 2, wherein
the imaging reference portion is a rod-like member protruding toward the imaging unit.

9. The conveyance detection apparatus of the conveying apparatus according to claim 8, wherein
the distance from the imaging unit to the conveyance path and a distance from the imaging unit to a tip of the rod-like member are substantially the same.

10. The conveyance detection apparatus of the conveying apparatus according to claim 2, wherein
the imaging reference portion is a light source.

11. A conveying apparatus comprising:
a conveying unit that conveys a conveyed object along a conveyance path;
an imaging unit that images the conveyed object and an object not conveyed by the conveying unit;
a conveyance detection unit that acquires actual conveyance information of the conveyed object from image information of the conveyed object imaged by the imaging unit and image information of the object imaged by the imaging unit; and
a housing that houses the conveying unit, the imaging unit, and the object.

12. A recording apparatus comprising:
a conveying unit that conveys a conveyed object along a conveyance path;
an imaging unit that images the conveyed object and an object not conveyed by the conveying unit;
a conveyance detection unit that acquires actual conveyance information of the conveyed object from image information of the conveyed object imaged by the imaging unit and image information of the object imaged by the imaging unit; and
a recording unit that records an image on the conveyed object based on conveyance information detected by the conveyance detection unit.
